(19) United States
(12) Patent Application Publication
(10) Pub. No.: US 2002/0179034 A1
(43) Pub. Date: Dec. 5, 2002

(54) Protective coating for internal combustion engine components

(75) Inventor: Kevin D. Sisken, Saline, MI (US)

Correspondence Address: Jeremy J. Curcuri, Brooks & Kushman P.C., 1000 Town Center, 22nd Floor, Southfield, MI, 48075-1351, US

(73) Assignee: Detroit Diesel Corporation, Detroit, MI

(21) Appl. No.: 09/874,431

(22) Filed: Jun. 4, 2001

(51) Int. Cl. F02B 77/00

(52) U.S. Cl. 123/198 A

(57) ABSTRACT

An internal combustion engine has a plurality of cylinders and includes an air system having a plurality of components. The air system includes an intake portion and an exhaust portion. At least one of the components has a protective coating that reduces a tendency of soot to adhere to the at least one component. Preferably, the protective coat also reduces a tendency of the at least one component to undergo corrosion.

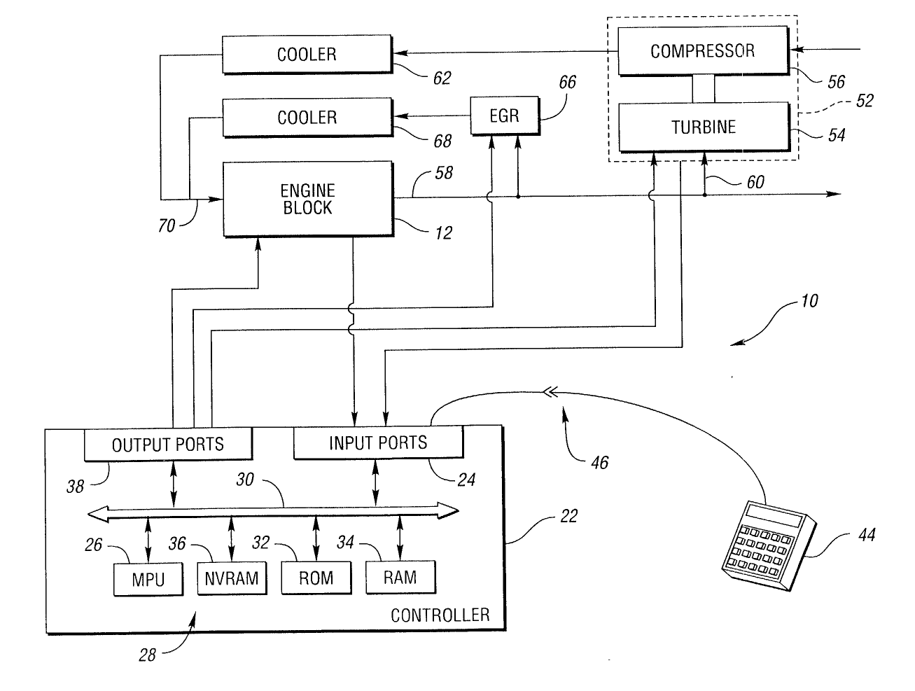

### BACKGROUND OF THE INVENTION

1. Field of the Invention

The present invention relates to internal combustion engines.

2. Background Art

The heavy duty engine business is extremely competitive. Increasing demands are being placed on engine manufacturers to design and build engines that provide better engine performance, improved reliability, and greater durability while meeting more stringent emission and noise requirements. One approach to meet more stringent emission requirements is to utilize an exhaust gas recirculation (EGR) system. Today, in diesel engines running with EGR, there is a problem that the soot in the EGR has a tendency to adhere to the parts it comes into contact with. This adhesion leaves a soot coating on EGR coolers, manifolds, sensors, intake valves, plumbing, etc. In low pressure EGR systems, the soot can also leave a soot coating on turbocharger compressor components, charge air coolers, assorted plumbing, etc. In short, any component that comes into contact with the exhaust gas flow in an EGR system can have soot adhere to it.

The adhesion of soot leads to a variety of issues, ranging from reducing cooler effectiveness, restricting air flow, fouling sensors, corroding parts because of the acidity of the soot, etc. For the foregoing reasons, there is a need for an improved internal combustion engine that reduces the tendency of soot to adhere to engine components.

### SUMMARY OF THE INVENTION

It is, therefore, an object of the present invention to provide an improved internal combustion engine wherein at least one of the components has a protective coating that reduces a tendency of soot to adhere to the at least one component.

In carrying out the above object, an internal combustion engine with a plurality of cylinders is provided. The engine includes an air system having a plurality of components. The air system includes an intake portion and an exhaust portion. At least one the components has a protective coating that reduces a tendency of soot to adhere to the at least one component.

In a preferred embodiment, the protective coating reduces a tendency of the at least one component to undergo corrosion. The protective coating may be applied to any of a number of components such as, for example, at least one component in the intake portion or at least one component in the exhaust portion. For example, an intake manifold, an intake valve, an exhaust manifold, and an exhaust valve are all examples of components that may receive the protective coating that reduces a tendency of soot to adhere to the component. Again, a preferred protective coating also reduces the tendency of the components to undergo corrosion. Given that the various components are made of a variety of different materials, the same or different coatings could be used for each component. For example, the protective coating applied to stainless steel parts could be different than the coating applied to aluminum parts. The difference could be in the make-up of the coating, how it is applied, the thickness of the coating, the need for bond coats or surface preparation before applying the coating, etc. Further, any number of components could be coated and the components named above are examples. Exemplary protective coatings include electroless nickel coating and a fluoropolymer coating such as polytetrafluoroethylene.

It is appreciated that the embodiments of the present invention are well suited for engines that include an exhaust gas recirculation system. That is, the protective coating may be applied to at least one component located in the exhaust gas recirculation system such as an exhaust gas recirculation cooler. Further, when the engine includes a turbocharging system, at least one component receiving the protective coating may be located in the turbocharging system. For example, a charge air cooler may receive the protective coating. Of course, it is appreciated that embodiments of the present invention are useful in engines having turbocharging systems and/or high or low pressure EGR systems, but of course, protective coatings of the present invention may be used in engines without turbocharging or EGR systems. It is appreciated that protective coatings of the present invention may be useful for a variety of engine components including, but not limited to, manifolds, valves, sensors, and coolers.

Further, in carrying out the present invention, a method of making an internal combustion engine with a plurality of cylinders is provided. The engine includes an air system having a plurality of components. The air system includes an intake portion and an exhaust portion. The method comprises applying a protective coating to at least one of the components. The protective coating reduces a tendency of soot to adhere to the at least one component.

In the preferred embodiments of the present invention, the protective coating reduces a tendency of the at least one component to undergo corrosion. It is appreciated that at least one component may be located in the intake portion or the exhaust portion of the air system. Exemplary coatings include an electroless nickel coating and a fluoropolymer coating such as polytetrafluoroethylene.

The advantages associated with embodiments of the present invention are numerous. For example, internal combustion engines having components with the protective coating that reduces a tendency of soot to adhere to the at least one component allows soot to pass smoothly through the system rather than adhering to surfaces. There are many applications where such a coating would be useful such as, for example, a compression ignition internal combustion engine including an EGR system. It is appreciated that the concept of using a coating that reduces the tendency of soot to adhere to a surface has other applications besides EGR system components. The protective coating may be applied to other systems on an internal combustion engine that come in contact with soot. For example, engine mufflers, vehicle exhaust plumbing, or components of other after treatment devices may be provided with the protective coating.

The above object and other objects, features, and advantages of the present invention are readily apparent from the following detailed description of the preferred embodiment when taken in connection with the accompanying drawings.

### BRIEF DESCRIPTION OF THE DRAWINGS

The Figure is a schematic diagram of an internal combustion engine and an engine control system made in accordance with an embodiment of the present invention.

### DETAILED DESCRIPTION OF THE PREFERRED EMBODIMENT

An internal combustion engine including associated control systems and subsystems is generally indicated at 10. Engine or system 10 includes an engine block 12 having a plurality of cylinders. In a preferred embodiment, engine 10 is a compression-ignition internal combustion engine, such as a heavy duty diesel fuel engine. The cylinders receive pressurized fuel from a fuel supply in a known manner. Block 12 represents intake and exhaust manifolds and valves, as well as other standard engine components in addition to representing the engine block.

Various sensors are in electrical communication with a controller 22 via input ports 24. Controller 22 preferably includes a microprocessor 26 in communication with various computer readable storage media 28 via data and control bus 30. Computer readable storage media 28 may include any of a number of known devices which function as read only memory 32, random access memory 34, and non-volatile random access memory 36.

Computer readable storage media 28 have instructions stored thereon that are executable by controller 22 to perform methods of controlling the internal combustion engine, including exhaust gas recirculation (EGR) valve 66 and turbocharger 52. The program instructions direct controller 22 to control the various systems and subsystems of the vehicle, with the instructions being executed by microprocessor 26. Input ports 24 receive signals from various sensors, and controller 22 generates signals at output ports 38 that are directed to the various vehicle components.

A data, diagnostics, and programming interface 44 may also be selectively connected to controller 22 via a plug 46 to exchange various information therebetween. Interface 44 may be used to change values within the computer readable storage media 28, such as configuration settings, and/or calibration variables.

In operation, controller 22 receives signals from the various vehicle sensors and executes control logic embedded in hardware and/or software to control the engine. In a preferred embodiment, controller 22 is the DDEC controller available from Detroit Diesel Corporation, Detroit, Michigan. Various other features of this controller are described in detail in a number of different U.S. patents assigned to Detroit Diesel Corporation.

As is appreciated by one of ordinary skill in the art, control logic may be implemented in hardware, firmware, software, or combinations thereof. Further, control logic may be executed by controller 22, in addition to by any of the various systems and subsystems of the vehicle cooperating with controller 22. Further, although in a preferred embodiment, controller 22 includes microprocessor 26, any of a number of known programming and processing techniques or strategy may be used to control an engine in accordance with the present invention.

Controller 22 provides enhanced engine performance by controlling a variable flow exhaust gas recirculation (EGR) valve 66 and by controlling turbocharger 52. Turbocharger 52 includes a turbine 54 and a compressor 56. The pressure of the engine exhaust gases causes the turbine to spin. The turbine drives the compressor, which is typically mounted on the same shaft. The spinning compressor creates turbo boost pressure which develops increased power during combustion. The exhaust gases pass from engine 12 through exhaust passage 58 and are selectively routed to turbine 54 at inlet 60. The present invention may be utilized in engines with or without a turbocharger. In engines with a turbocharger, the turbocharger may or may not be electronically controlled.

An exhaust gas recirculation system introduces a metered portion of the exhaust gases into the intake manifold. The EGR system dilutes the incoming fuel charge and lowers combustion temperatures to reduce the level of oxides of nitrogen. The amount of exhaust gas to be recirculated is controlled by EGR valve 66. It is appreciated that there are many possible configurations for an EGR valve, and embodiments of the present invention are not limited to any particular structure for the EGR valve. Further, it is appreciated that embodiments of the present invention may be employed in engines with or without an EGR system.

In some embodiments, it may be desirable to provide a cooler 62 to cool the charge air coming from compressor 56. Similarly, in some embodiments, it may be desirable to provide a cooler 68 to cool the flow through the EGR system prior to reintroduction to engine 12 of the gases at intake passage 70. The flow path from EGR valve 66 through cooler 68 illustrates a high pressure EGR system. In embodiments of the present invention that have an EGR system, the EGR system may alternatively be a low pressure EGR system where the exhaust gas is taken from the exhaust stream downstream of the turbine and introduced at the compressor inlet.

As explained above, internal combustion engine 10 includes an air system having a plurality of components. The air system includes an intake portion and an exhaust portion. As shown, the intake portion of the air system includes compressor 56, charge air cooler 62, inlet port 70 and the intake manifold (represented by block 12). The exhaust portion of the air system includes exhaust passage 58 and the exhaust manifold (represented by block 12). Of course, it is appreciated that engine 10 is exemplary, and that embodiments of the present invention may be implemented in engines having different components than those illustrated. According to the present invention, at least one of the air system components has a protective coating that reduces a tendency of soot to adhere to the component. Any number of components may receive the protective coating. For example, intake components including the intake manifold, exhaust components including the exhaust manifold, valves, sensors, and coolers, may all receive the protective coating, if desired. In accordance with the present invention, the coating is applied to prevent soot from adhering to parts of an internal combustion engine. A suitable coating does not allow soot to adhere thereto, or at least reduces the tendency of soot to adhere to the coating. Although embodiment of the present invention may be employed in any engine, the protective coating may be particularly useful to prevent soot from adhering to the components of the EGR system. The protective coating may be any suitable coating as understood by one of ordinary skill in the art. For example, the protective coating may be polymer based, a high temperature applied coating, a surface treatment, a combination of these or other coating techniques, etc. In any case, the protective coating should be selected with the right surface and surface energy characteristics to prevent soot adhesion. Bond coats and layering of the protective coating may be appropriate in some applications as appreciated by one of ordinary skill in the art. Preferably, the protective coating is applied permanently at the time of initial engine build or component manufacture, but if required, the protective coating could be reapplied via various means if the effectiveness of the coating degrades over time.

For example, any number of components in the intake or exhaust portions of the air system of engine 10 may be provided with the protective coating. Further, for example, the intake and exhaust manifolds and intake and exhaust valves at engine block 12 may be provided with the protective coating. Even further, any EGR system components or turbocharger system components may be coated. Advantages associated with utilizing protective coatings of the present invention are numerous. Benefits of the protective coating may include increased durability, reliability, repeatability, and the ability to maintain the system functionality over an extended period of time.

All or individual parts could be coated to prevent adhesion. Given that the components are made of a variety of different materials, the same or different coatings would be needed for each component. The coating applied to stainless steel parts could be different that those applied to aluminum. This difference could be in the make-up of the coating, how it is applied, the thickness of the coating, the need for bond coats or surface preparation before applying the coating, etc.

It is appreciated that the concept of using a coating that does not allow soot to adhere to a surface has other applications besides EGR system components. The protective coating may be utilized in other systems on an internal combustion engine that come in contact with soot. For example, protective coatings of the present invention could be utilized in engine mufflers, vehicle exhaust plumbing, or components of other after treatment devices.

A preferred coating, in addition to repelling soot, reduces a tendency of the coated component to undergo corrosion. That is, a preferred coating prevents acidic corrosion sometimes caused when acids condense on or upstream of these components. It is appreciated that any suitable coating for a particular component may be selected by one of ordinary skill in the art based on the disclosure provided herein, however, two coating examples are given below. A first example of a protective coating is electroless nickel. Electroless nickel will reduce the amount of soot that will adhere to system parts and will also protect the base material from acidic corrosion. Another example of a protective coating is a fluoropolymer such as polytetrafluoroethylene. Such a coating would repel a significant amount of soot and may offer some level of corrosion protection depending on the particular formulation selected for the protective coating. In addition, in accordance with the present invention, different coatings can be used for different parts within the engine, depending on the base material and the amount of soot and/or acidic corrosion that is being experienced.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An internal combustion engine with a plurality of cylinders, the engine including an air system having a plurality of components, the air system including an intake portion and an exhaust portion wherein at least one of the components has a protective coating that reduces a tendency of soot to adhere to the at least one component.

2. The engine of claim 1 wherein the protective coating reduces a tendency of the at least one component to undergo corrosion.

3. The engine of claim 1 wherein the at least one component is located in the intake portion.

4. The engine of claim 1 wherein the at least one component is located in the exhaust portion.

5. The engine of claim 1 wherein the protective coating comprises an electroless nickel coating.

6. The engine of claim 1 wherein the protective coating comprises a fluoropolymer coating.

7. The engine of claim 1 wherein the at least one component is an intake manifold.

8. The engine of claim 1 wherein the at least one component is an intake valve.

9. The engine of claim 1 wherein the at least one component is an exhaust manifold.

10. The engine of claim 1 wherein the at least one component is an exhaust valve.

11. The engine of claim 1 wherein the engine includes an exhaust gas recirculation system and wherein the at least one component is located in the exhaust gas recirculation system.

12. The engine of claim 11 wherein the at least one component is an exhaust gas recirculation cooler.

13. The engine of claim 1 wherein the engine includes a turbocharging system and wherein the at least one component is located in the turbocharging system.

14. The engine of claim 13 wherein the at least one component is a charge air cooler.

15. The engine of claim 1 wherein the at least one component is a sensor.

16. A method of making an internal combustion engine with a plurality of cylinders, the engine including an air system having a plurality of components, the air system including an intake portion and an exhaust portion, the method comprising:
applying a protective coating to at least one of the components, the protective coating reducing a tendency of soot to adhere to the at least one component.

17. The method of claim 16 wherein the protective coating reduces a tendency of the at least one component to undergo corrosion.

18. The method of claim 16 wherein the at least one component is located in the intake portion.

19. The method of claim 16 wherein the at least one component is located in the exhaust portion.

20. The method of claim 16 wherein the protective coating comprises an electroless nickel coating.

21. The method of claim 16 wherein the protective coating comprises a fluoropolymer coating.

22. A compression ignition internal combustion engine with a plurality of cylinders, the engine including an air system having a plurality of components, the air system including an intake portion and an exhaust portion, the engine further including an exhaust gas recirculation system having at least one component with a protective coating that reduces a tendency of soot to adhere to the at least one component.
